(19) United States
(12) Patent Application Publication
(10) Pub. No.: US 2012/0133646 A1
(43) Pub. Date: May 31, 2012

(54) IMAGE PROCESSING APPARATUS, METHOD FOR HAVING COMPUTER PROCESS IMAGE AND COMPUTER READABLE MEDIUM

(75) Inventor: Keisuke Azuma, Ichikawa-Shi (JP)

(73) Assignee: KABUSHIKI KAISHA TOSHIBA, Tokyo (JP)

(21) Appl. No.: 13/232,926

(22) Filed: Sep. 14, 2011

(30) Foreign Application Priority Data
Nov. 25, 2010 (JP) 2010-262732

(51) Int. Cl. G06T 15/00

(52) U.S. Cl. 345/419

(57) ABSTRACT

According to one embodiment, an image processing apparatus includes a fixed point setting module, a sampling point setting module, and a parallax image generator. The fixed point setting module sets a fixed point to a sampling coordinate space generated from first image data including a first pixel. The sampling point setting module sets a target point to the sampling coordinate space, and sets a sampling point corresponding to the target point to a calculated sampling coordinate. The parallax image generator calculates a pixel value of a second pixel to be located on the sampling coordinate, and generates plural pieces of second image data, each second image data including the second pixel.

### CROSS REFERENCE TO RELATED APPLICATIONS

This application is based upon and claims the benefit of priority from the prior Japanese Patent Application No. 2010-262732, filed on, Nov. 25, 2010, the entire contents of which are incorporated herein by reference.

### FIELD

Embodiments described herein relate generally to image processing apparatus, method for having a computer process image, and computer readable medium.

### BACKGROUND

Recently, with widespread of a display that can display a three-Dimension (3D) image, there is a demand for converting an existing two-dimensional (2D) image into the 3D image (hereinafter referred to as “2D-3D conversion”) in addition to providing 3D contents. In general 2D-3D conversion, depth estimation and parallax image generation are performed.

However, in general depth estimation, because complete depth information is not obtained from the 2D image, the depth information is estimated using a predetermined algorithm. As a result, when the estimated depth information indicates a depth differs from that of an original image, a viewer senses a discomfort at the displayed 3D image.

Moreover, in general parallax image generation, a hidden portion that does not exist in the original image is interpolated. The hidden portion tends to become a factor that degrades image quality. Accordingly, the interpolation of the hidden portion has an undesirable effect on quality of the generated 3D image.

In addition, it is necessary to process huge amounts of information in both the general depth estimation and the general parallax image generation. On the other hand, in the 2D-3D conversion, there is a need for quick processing in order to display the 3D image in real time. Accordingly, the 2D-3D conversion cannot be implemented in a compact device, such as a mobile phone, which does not include a large-scale processor that quickly executes an algorithm for implementing the depth estimation and the parallax image generation.

### BRIEF DESCRIPTION OF THE DRAWINGS

FIG. 1 is a block diagram of an image processing system 1 according to the embodiment.

FIG. 2 is a view illustrating a structure of first image data IMG of the embodiment.

FIG. 3 is a block diagram illustrating the image processing apparatus 10a of the first embodiment.

FIG. 4 is a flowchart illustrating a 2D-3D conversion of the first embodiment.

FIG. 5 is a schematic diagram of the sampling coordinate space CS to represent the 2D-3D conversion of the first embodiment.

FIG. 6 is a flowchart of the sampling point set of the first embodiment.

FIGS. 7A-7C are views illustrating the sampling set of the first embodiment.

FIG. 8 is a view illustrating a structure of the second image data IMG′.

FIG. 9 is a flowchart illustrating the parallax image generation of the first embodiment.

FIGS. 10A and 10B are views illustrating an example in which the pixel value of the second pixel of the first embodiment is calculated.

FIG. 11 is a block diagram illustrating the image processing apparatus 10a of the second embodiment.

FIG. 12 is a flowchart illustrating a 2D-3D conversion of the second embodiment.

FIG. 13 is a flowchart illustrating the depth information generation of the second embodiment.

FIGS. 14A, 14B, 15A and 15B are views illustrating depth generation of the second embodiment.

FIGS. 16A and 16B are views illustrating sampling point correction of the second embodiment.

### DETAILED DESCRIPTION

Embodiments will now be explained with reference to the accompanying drawings.

In general, according to one embodiment, an image processing apparatus includes a fixed point setting module, a sampling point setting module, and a parallax image generator. The fixed point setting module sets a fixed point to a sampling coordinate space generated from first image data including a first pixel. The sampling point setting module sets a target point to the sampling coordinate space, and sets a sampling point corresponding to the target point to a calculated sampling coordinate. The parallax image generator calculates a pixel value of a second pixel to be located on the sampling coordinate, and generates plural pieces of second image data, each second image data including the second pixel.

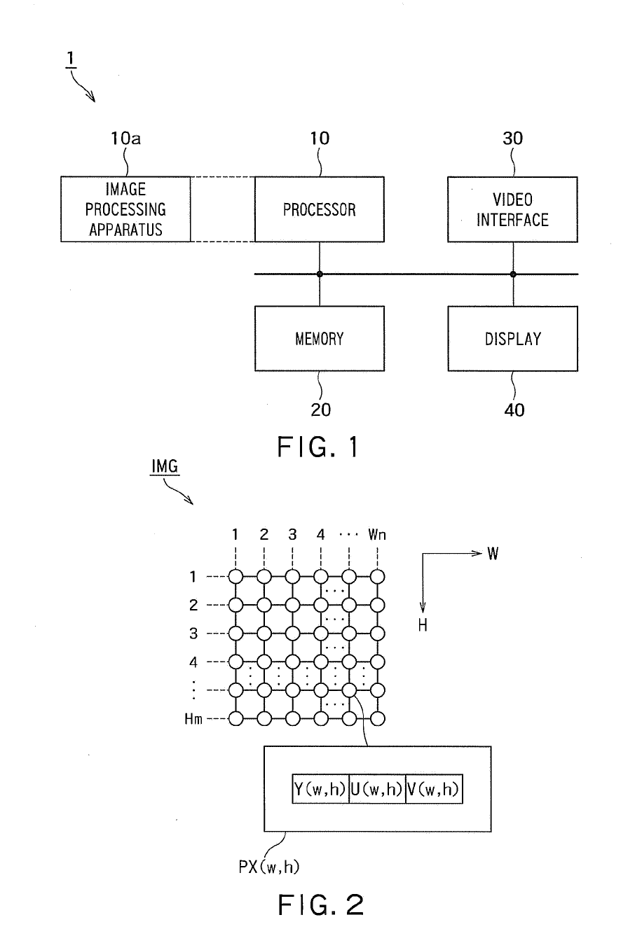

Embodiments of the present invention will be described more specifically with reference to the drawings. FIG. 1 is a block diagram of an image processing system 1 according to the embodiment. The image processing system 1 includes a processor 10, a memory 20, a video interface 30, and a display 40. The processor 10 is operated as an image processing apparatus 10a when executing a predetermined image processing program. The image processing apparatus 10a generates at least two parallax images from the 2D image based on setting information provided from hardware or software, which utilizes the image processing apparatus 10a. The memory 20 is a computer readable medium such as a Dynamic Random Access Memory (DRAM) in which various pieces of data can be stored. The various pieces of data include first image data expressing the 2D image and second image data expressing at least the two parallax images generated by the image processing apparatus 10a. The first image data is input to the video interface 30 from an external device connected to the image processing system 1, and the video interface 30 outputs the second image data to the external device. The video interface 30 includes a decoder that decodes the coded first image data and an encoder that codes the second image data. The display 40 is a module, such as a 3D LCD (Liquid Crystal Display) television, which displays an image. In addition, the display 40 may be eliminated.

FIG. 2 is a view illustrating a structure of first image data IMG of the embodiment. The first image data IMG includes Wm×Hm (Wm and Hm are natural numbers) first pixels PX that are arrayed in a W-direction and an H-direction in a first coordinate space having a W-axis and an H-axis. The first pixel PX(w,h) is located on a coordinate (w,h) (1≦w≦Wm and 1≦h≦Hm). For example, each first pixel PX includes a pixel value (a brightness component Y, a first difference component U, and a second difference component V) that is defined by a YUV format. The brightness component Y(w,h) is a pixel value indicating brightness of the first pixel PX(w,h). The first difference component U(w,h) is a pixel value indicating a difference of a blue component of the first pixel PX(w,h). The second difference component V(w,h) is a pixel value indicating a difference of a red component of the first pixel PX(w,h). For example, each of the brightness component Y, the first difference component U, and the second difference component V is expressed by 8-bit signals of 0 to 255 (256 tones). The image processing system 1 can also deal with image data including a pixel value defined by another format (for example, an RGB format).

### FIRST EMBODIMENT

An image processing apparatus according to a first embodiment will be described below. In the image processing apparatus of the first embodiment, a sampling point is set closer to a fixed point as a target point is located closer to an arbitrary fixed point, and the sampling point is set farther away from the fixed point as the target point is located farther away from the fixed point.

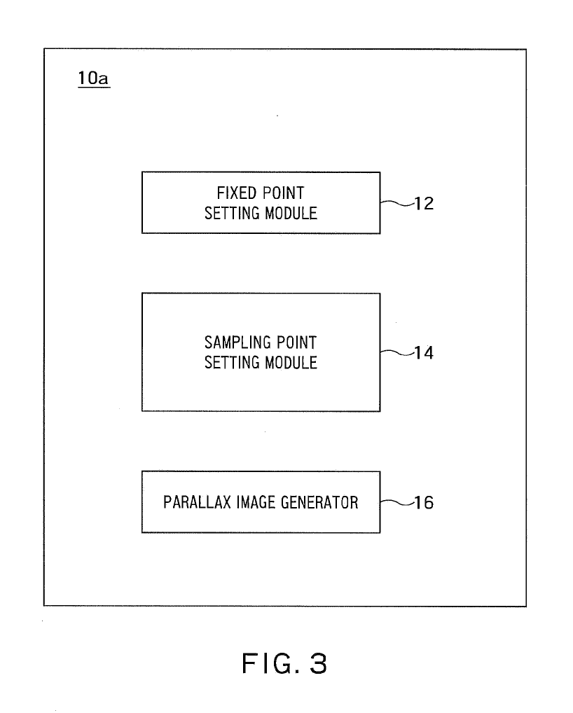

A configuration of the image processing apparatus of the first embodiment will be described. FIG. 3 is a block diagram illustrating the image processing apparatus 10a of the first embodiment. The image processing apparatus 10a includes a fixed point setting module 12, a sampling point setting module 14, and a parallax image generator 16.

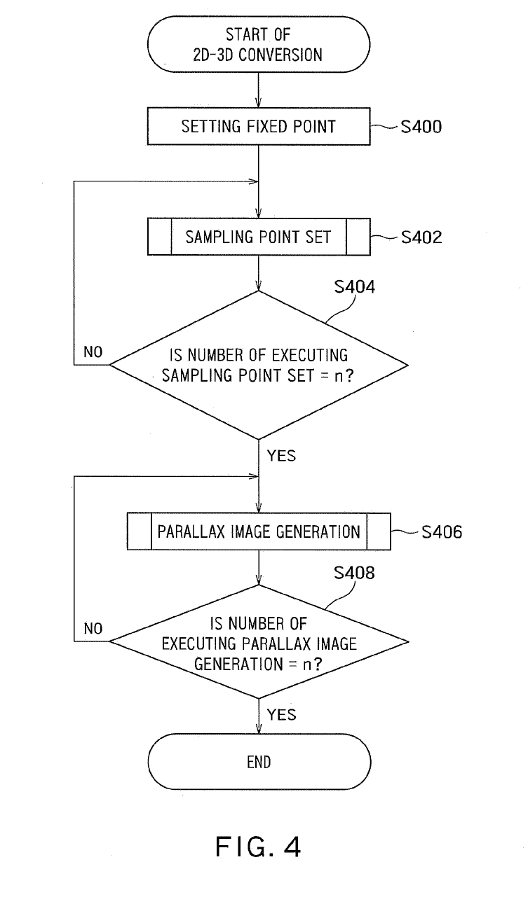

An operation of the image processing apparatus of the first embodiment will be described. FIG. 4 is a flowchart illustrating a 2D-3D conversion of the first embodiment. The 2D-3D conversion is executed by the processor 10 that is operated as the image processing apparatus 10a.

<S400> The fixed point setting module 12 generates Xm×Ym sampling coordinate spaces CS from the first coordinate space based on predetermined sampling resolution and sets n (n is an integer of 2 or more) arbitrary fixed points V to the generated sampling coordinate space CS.

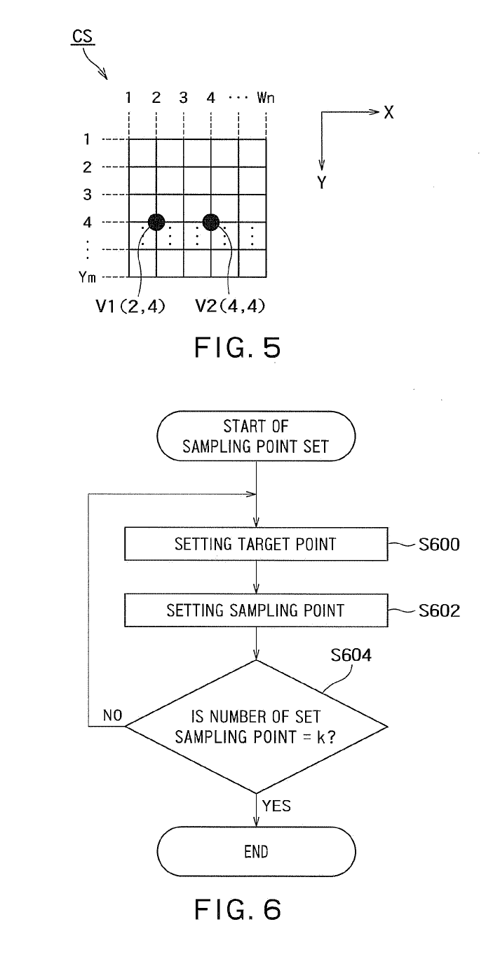

FIG. 5 is a schematic diagram of the sampling coordinate space CS to represent the 2D-3D conversion of the first embodiment. In FIG. 5, a fixed point V1(2,4) is set to a coordinate (x,y)=(2,4), and a fixed point V2(4,4) is set to a coordinate (x,y)=(4,4). The sampling resolution may be a predetermined fixed value or may be calculated by using information indicating predetermined sampling resolution. For example, the fixed point V is set to the coordinate in the sampling coordinate space CS, the coordinate included in a front area that is estimated to be located forward in the 3D image or a rear area that is estimated to be located rearward in the 3D image when the 2D image is converted into the 3D image. For example, the fixed point V1 is a point used to generate a parallax image for a right eye, and the fixed point V2 is a point used to generate a parallax image for a left eye. At this point, n indicates the number of parallax images to be generated, and n is fixed by information indicating the predetermined number of parallax images to be generated.

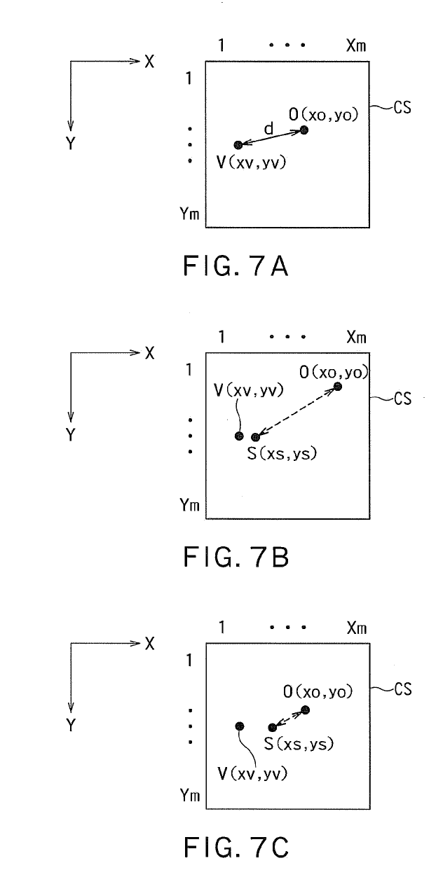

By way of example, the fixed point setting module 12 estimates the depth of the 2D image from the first image data IMG and performs mapping of estimation result to generate a depth map. Then, the fixed point setting module 12 refers to the generated depth map to set the fixed point V to an arbitrary point included in the specified front area. Alternatively, the fixed point setting module 12 may analyze an image characteristic, determine an image scene (for example, a sport scene or a landscape scene) based on the analysis result, and set the fixed point V to an arbitrary point included in the front area specified based on the determination result. Alternatively, the fixed point setting module 12 may set the fixed point V based on predetermined information indicating a coordinate of the fixed point V.

<S402> The sampling point setting module 14 sets a target point O to an arbitrary coordinate in the sampling coordinate space and executes sampling point set to set the sampling point S corresponding to the target point O based on the pixel component of the image data IMG. FIG. 6 is a flowchart of the sampling point set of the first embodiment. FIGS. 7A-7C are views illustrating the sampling set of the first embodiment.

<S600> As illustrated in FIG. 7A, the sampling point setting module 14 sets a target point O(xo,yo) to an arbitrary coordinate (xo,yo) in the sampling coordinate space CS generated by the fixed point setting module 12. The target point O(xo,yo) is a point that is a reference of the sampling point S in the sampling coordinate space CS.

<S602> The sampling point setting module 14 sets the sampling point S corresponding to the target point O based on the pixel component of the fixed point V and the pixel component of the target point O. For example, the sampling point setting module 14 uses at least one of the coordinate and the pixel value as the pixel component.

When the coordinate is used as the pixel component, the sampling point setting module 14 calculates a distance d between a fixed point V(xv,yv) and a target point o(xo,yo) using Equation 1. In Equation 1, dx is a distance between the target point O and the fixed point V in an X-direction in the sampling coordinate space CS, and dy is a distance between the target point O and the fixed point V in a Y-direction in the sampling coordinate space CS.

[Formula 1]

d=\sqrt{dx²+dy²}

dx=\sqrt{(xo−xv)²}

dy=\sqrt{(yo−yv)²} (Equation 1)

Next, as illustrated in FIGS. 7B and 7C, using Equation 2, the sampling point setting module 14 calculates a sampling coordinate (xs,ys) to which the sampling point S is set, based on the calculated distance d. Then, the sampling point setting module 14 sets the sampling point S(xs,ys) onto the calculated sampling coordinate (xs,ys). In Equation 2, f(d) and g(d) are a conversion function of the distance d between the fixed point V and the target point O. For example, f(d) and g(d) are a positive increasing function, a positive decreasing function, or a constant. In the sampling coordinate space CS, the sampling point S is set such that the distance between the fixed point V and the sampling point S is decreased with decreasing distance d and such that the distance between the fixed point V and the sampling point S is increased with increasing distance d (see FIGS. 7B and 7C). As a result, the sampling point S is set such that the parallax image, in which pixel density is increased in an area peripheral to the fixed point V and the pixel density is decreased in an area far away from the fixed point V, is generated.

[Formula 2]

xs=xv±f(d)*dx

ys=yv±g(d)*dy (Equation 2)

When the pixel value (for example, the brightness component Y) is used as the pixel component, using Equation 3, the sampling point setting module 14 calculates the sampling coordinate (xs,ys) based on a brightness component Yo of the target point O(xo,yo). Then, the sampling point setting module 14 sets the sampling point S(xs,ys) onto the calculated sampling coordinate (xs,ys). In Equation 3, h(Yo) and i(Yo) are a conversion function from the target point O into the brightness component Yo. For example, h(Yo) and i(Yo) are a positive increasing function, a positive decreasing function, or a constant. In the sampling coordinate space CS, the sampling point S is set such that the distance between the fixed point V and the sampling point S is decreased with decreasing brightness component Yo and such that the distance between the fixed point V and the sampling point S is increased with increasing brightness component Yo. As a result, the sampling point S is set such that the parallax image, in which the pixel density is increased in an area having the small brightness component Yo and the pixel density is decreased in an area having the large brightness component Yo, is generated.

[Formula 3]

xs=xo±h(Yo)

ys=yo±i(yo) (Equation 3)

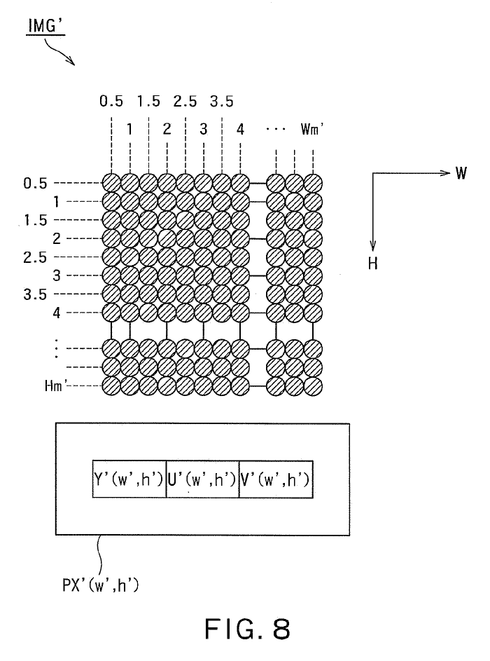

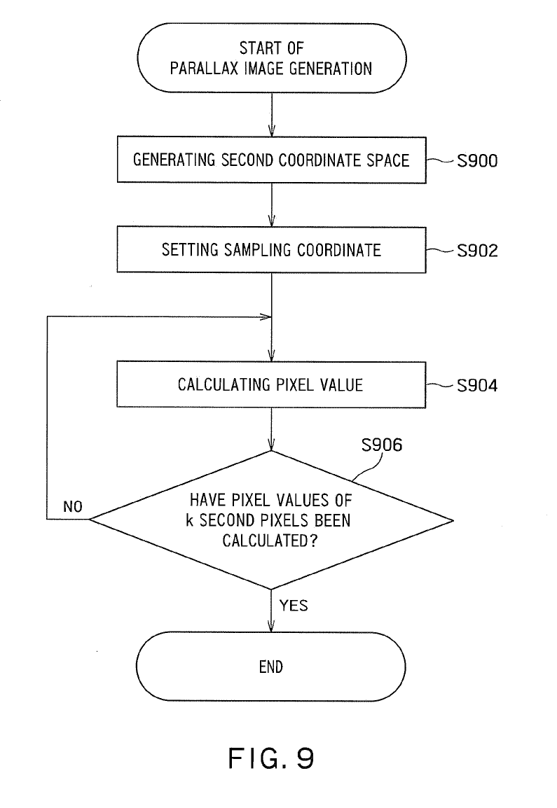

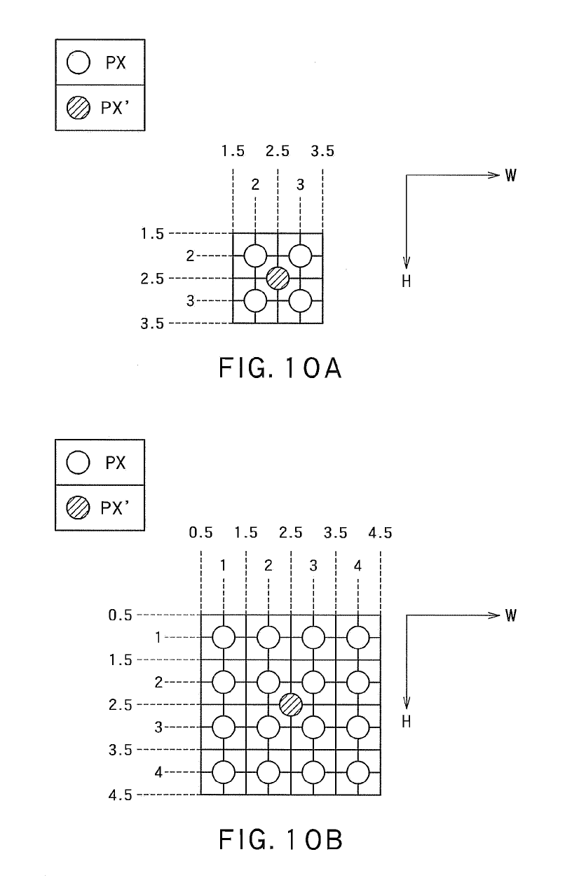

Incidentally, the pixel value used as the pixel component is not limited to the brightness component Y. The first difference component U, the second difference component V, the red component R, the green component G, or the blue component B may be used as the pixel component, or another pixel component may be used. In any case, in the sampling coordinate space CS, the sampling point S is set such that the distance between the fixed point V and the sampling point S is decreased with decreasing pixel component and such that the distance between the fixed point V and the sampling point S is increased with increasing pixel component. In other words, the sampling point S is located so as to become coarse for the fixed point V with decreasing pixel component and so as to become dense for the fixed point V with increasing pixel component.

<S604> The sampling point setting module 14 determines whether the k (k is an integer of 2 or more) sampling points S are set. The value of k depends on resolution of the 3D image. For example, the value of k is calculated by resolution set information indicating the resolution of the 3D image. When the set number of sampling points does not reach k (NO in S604), the flow returns to S600. When the set number of sampling points reaches k (YES in S604), the sampling point set is ended.

<S404> The sampling point setting module 14 determines whether the number of executing times of the sampling point set (S402) reaches n. When the number of executing times of the sampling point set does not reach n (NO in S404), the flow returns to S402. When the number of executing times of the sampling point set reaches n (YES in S404), the flow goes to S406.

<S406> The parallax image generator 16 calculates a pixel value of a second pixel P′ to be located on the sampling coordinate of the set sampling point. Then, the parallax image generator 16 executes parallax image generation to generate at least two pieces of second image data IMG′ including the plural second pixels P′. FIG. 8 is a view illustrating a structure of the second image data IMG′. The second image data IMG′ includes Wm′×Hm′ (Wm′ and Hm′ are natural numbers) second pixels PX′ that are arrayed in the W-direction and the H-direction in a second coordinate space having the W-axis and the H-axis. The second pixel PX′(w′,h′) is located on a coordinate (w′,h′). Each second pixel PX′ includes a pixel value (a brightness component Y′, a first difference component U′, and a second difference component V′) that is defined by, for example, the YUV format. The brightness component Y′(w′,h′) is a pixel value indicating brightness of the second pixel PX′(w′,h′). The first difference component U′(w′,h′) is a pixel value indicating a difference of a blue component of the second pixel PX′(w′,h′). The second difference component V′(w′,h′) is a pixel value indicating a difference of a red component of the second pixel PX′(w′,h′). FIG. 9 is a flowchart illustrating the parallax image generation of the first embodiment.

<S900> The parallax image generator 16 generates a second coordinate space of the second image data IMG′ based on the resolution set information. As illustrated in FIG. 8, the second coordinate space includes Wm′×Hm′(=k) coordinates. The size of the second coordinate space depends on the number of sampling points S set by the sampling point setting module 14. For example, when the resolution set information indicates the same size (that is, the 3D image having the same resolution as the 2D image is generated), the parallax image generator 16 generates the second coordinate space having the same size as the first coordinate space. In this case, Wm′=Wm and Hm′=Hm. For example, when the resolution set information indicates double (that is, the 3D image having the resolution double the 2D image is generated), the parallax image generator 16 generates the second coordinate space having the size double the first coordinate space. In this case, Wm′=2Wm and Hm′=2Hm.

<S902 and S904> The parallax image generator 16 sets the sampling coordinates corresponding to the k sampling points to the second coordinate space, respectively (S902). Then the parallax image generator 16 calculates the pixel value (Y′,U′,V′) of the second pixels PX′ to be located on the k sampling coordinates (S904). That is, the parallax image generator 16 calculates the pixel values of the second pixels from the pixel values of the first image data IMG which are located peripheral to the sampling coordinate. FIGS. 10A and 10B are views illustrating an example in which the pixel value of the second pixel of the first embodiment is calculated. As illustrated in FIG. 10A, the parallax image generator 16 calculates an average value of the pixel values of four pixels PX(2,2) to PX(3,3) of the first image data IMG, which are located peripheral to the sampling coordinate (2.5,2.5), as the pixel value of the second pixel PX′(2.5,2.5). Or, as illustrated in FIG. 10B, the parallax image generator 16 may weight and add the pixel values of 16 pixels PX(1,1) to PX(4,4) of the first image data IMG, which are located peripheral to the sampling coordinate (2.5,2.5), and calculate the result of the weighting-addition as the pixel value of the second pixel PX′(2.5,2.5).

<S906> The parallax image generator 16 determines whether the pixel values of the k second pixels PX′ are calculated. When the pixel values of the k second pixels PX′ are not calculated (NO in S906), the flow returns to S904. When the pixel values of the k second pixels PX′ are calculated (YES in S906), the parallax image generation is ended.

<S408> The parallax image generator 16 determines whether the number of executing times of the parallax image generation (S406) reaches n. When the number of executing times of the parallax image generation (S406) does not reach n (NO in S408), the flow returns to S406. When the number of executing times of the parallax image generation (S406) reaches n (YES in S408), the 2D-3D conversion is ended.

According to the first embodiment, the image processing apparatus 10a includes the fixed point setting module 12, the sampling point setting module 14, and the parallax image generator 16. The fixed point setting module 12 generates the sampling coordinate space fixed corresponding to the predetermined sampling resolution from the first image data including the plural first pixels, and sets the plural arbitrary fixed points to the generated sampling coordinate space. The sampling point setting module 14 sets the target point to the arbitrary coordinate in the sampling coordinate space, calculates the sampling coordinate based on the distance between the fixed point and the target point, and sets the sampling point corresponding to the target point to the calculated sampling coordinate. The parallax image generator 16 calculates the pixel value of the second pixel to be located on the sampling coordinate, and generates the plural pieces of second image data including the plural second pixels. As a result, the image data expressing the deep parallax image is generated although amount of process is small. Therefore, the 2D-3D conversion with small amount of process can be executed without degrading the quality of the 3D image that is displayed based on the parallax image. Regarding the image in which an object is located on a front side while a background is located in the back, the deep parallax image in the background and the object can be obtained.

### SECOND EMBODIMENT

An image processing apparatus according to a second embodiment will be described below. In the image processing apparatus of the second embodiment, depth information on the image is generated based on the pixel value of the 2D image, and a position of the sampling point is corrected based on the generated depth information. Incidentally, in the second embodiment, the same description as the first embodiment will not be repeated.

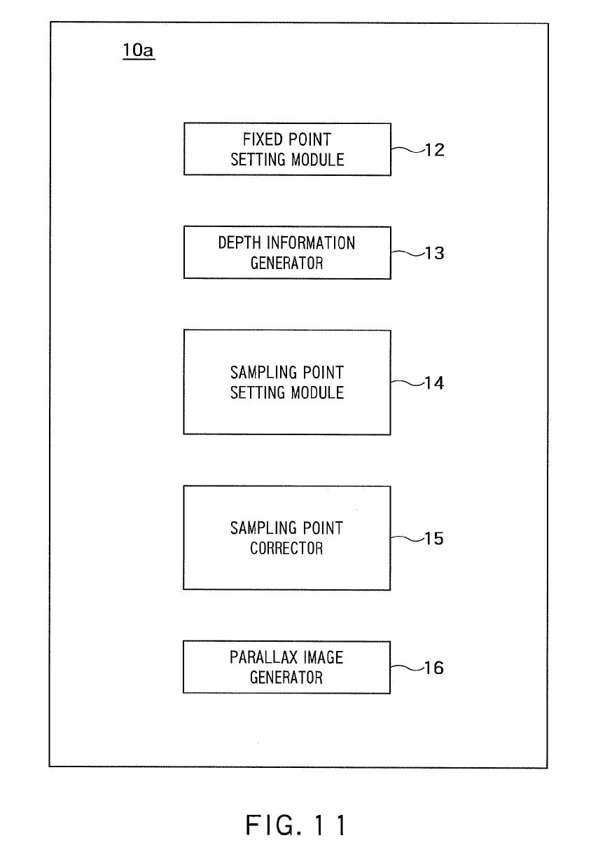

A configuration of the image processing apparatus of the second embodiment will be described. FIG. 11 is a block diagram illustrating the image processing apparatus 10a of the second embodiment. The image processing apparatus 10a includes the fixed point setting module 12, a depth information generator 13, the sampling point setting module 14, a sampling point corrector 15, and the parallax image generator 16.

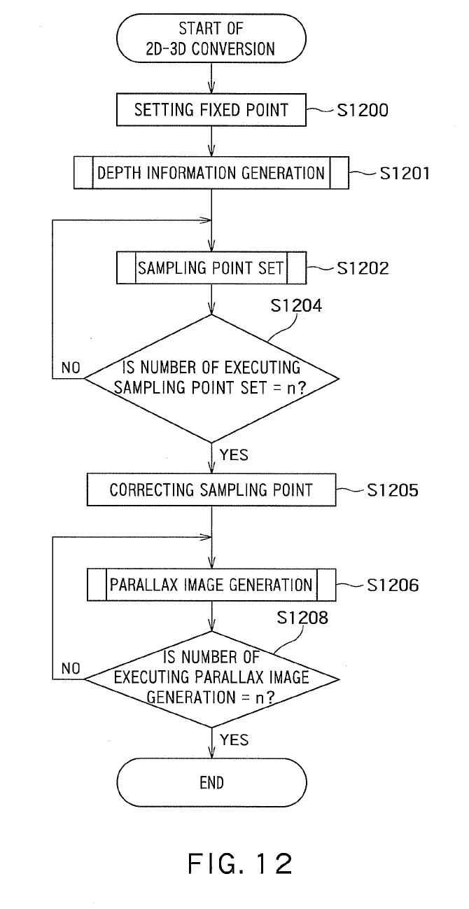

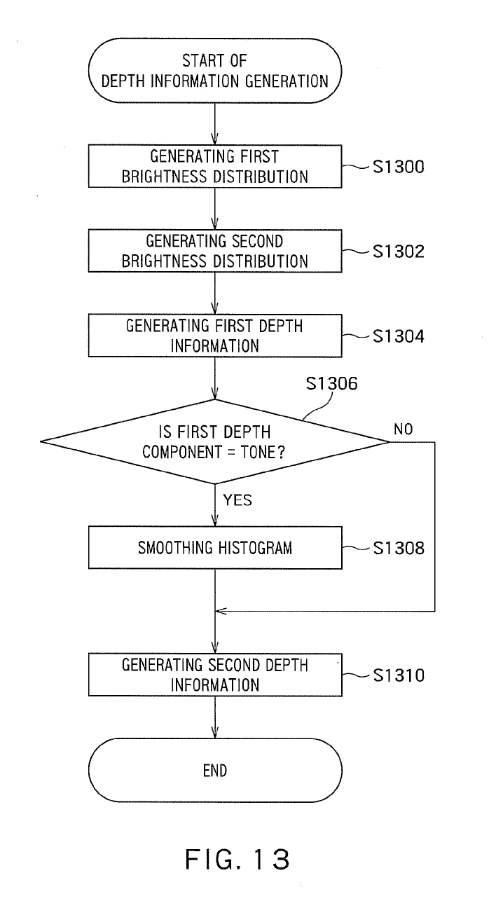

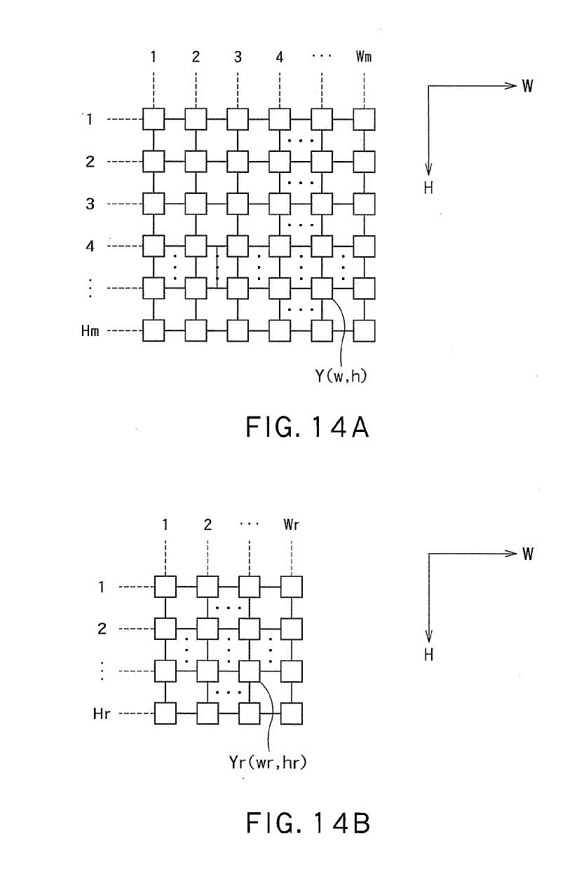

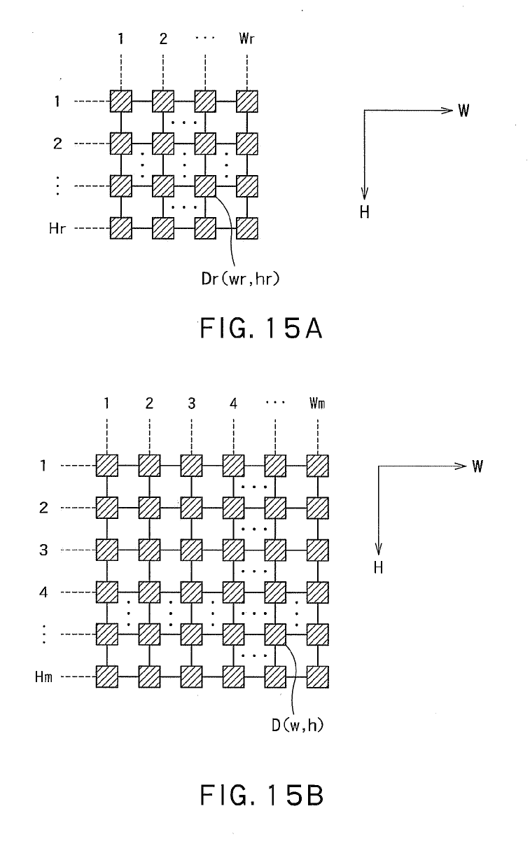

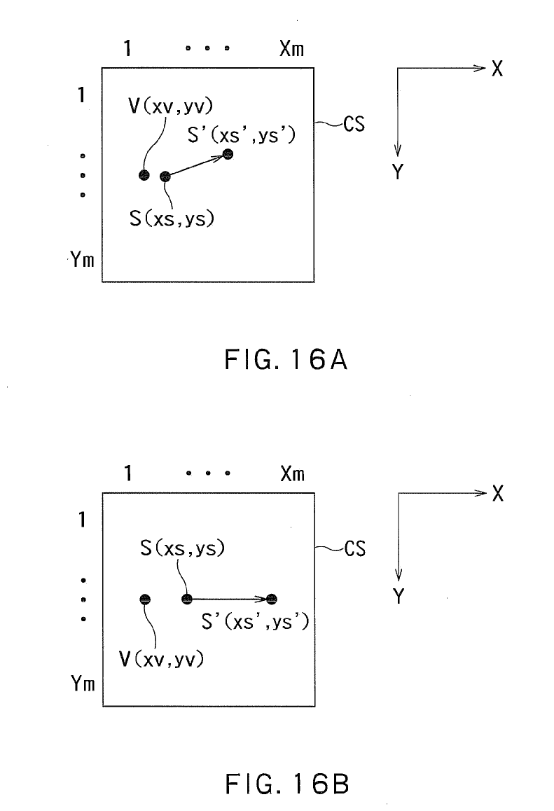

An operation of the image processing apparatus of the second embodiment will be described. FIG. 12 is a flowchart illustrating a 2D-3D conversion of the second embodiment. The 2D-3D conversion is executed by the processor 10 that is operated as the image processing apparatus 10a.

<S1200 and S1201> In S1200, processing similar to the setting fixed point (S400) of the first embodiment is executed. Then the depth information generator 13 executes depth information generation to generate the depth information based on the brightness component Y of the pixel value of the first pixel PX (S1201). The depth information indicates a depth of the first image data IMG. FIG. 13 is a flowchart illustrating the depth information generation of the second embodiment. FIGS. 14 and 15 are views illustrating depth generation of the second embodiment.

<S1300> The depth information generator 13 extracts the first brightness components Y(w,h) of the Wm×Hm first pixels PX(w,h) of the first image data IMG. Then, the depth information generator 13 generates a first brightness distribution (FIG. 14A) including the extracted Wm×Hm first brightness components Y(w,h). The first brightness distribution corresponds to the first coordinate space.

<S1302> The depth information generator 13 contracts the first brightness distribution to generate a second brightness distribution (see FIG. 14B) including Wr×Hr (Wr and Hr are natural numbers) second brightness components Yr(wr,hr). For example, using a bi-linear method, a bi-cubic method, or a single-averaging method, the depth information generator 13 smoothes a frequency of the second brightness distribution by applying a M×N (M and N are natural numbers) tap filter to the second brightness components Yr(wr,hr) calculated from the first brightness components Y(w,h).

<S1304> The depth information generator 13 converts the second brightness component Yr(wr,hr) into a predetermined depth value Dr(wr,hr), thereby generating first depth information (FIG. 15A) including the Wr×Hr first depth components Dr(wr,hr).

<S1306> The depth information generator 13 compares tone setting information indicating a tone of the depth information and a tone of the first depth component Dr(wr,hr). When the tone indicated by the tone setting information is equal to the tone of the first depth component Dr(wr,hr) (NO in S1306), the flow goes to S1310 without changing the tone. When the tone indicated by the tone setting information differs from the tone of the first depth component Dr(wr,hr) (YES in S1306), the flow goes to S1308 to change the tone.

<S1308> The depth information generator 13 shapes (stretches, contracts, or optimizes) a histogram of the first depth information Dr(wr,hr) to change the tone of the first depth component Dr(wr,hr) (S1308). Therefore, the depth information expressed by the desired tone is obtained.

<S1310> The depth information generator 13 generates second depth information by linearly expanding the first depth information. As shown in FIG. 15B, the second depth information includes the Wm×Hm second depth components D(w,h), thereby obtaining depth information including a coordinate space having the same resolution as the first image data IMG. The obtained depth information indicates a depth of the 2D image.

<S1202 and S1204> S1202 and S1204 are similar to those of the first embodiment. That is, the sampling point setting module 14 executes the sampling point set to set the sampling point S based on the pixel component of the image data IMG (S1202). When the number of executing times of the sampling point set does not reach n (NO in S1204), the flow returns to S1202. When the number of executing times of the sampling point set reaches n (YES in S1204), the flow goes to S1205.

<S1205> The sampling point corrector 15 corrects the sampling coordinate of the sampling point S based on the generated second depth information, thereby obtaining the sampling point S in which the depth of the 2D image is taken into account. Specifically, the sampling point corrector 15 fixes a correction amount AS of the sampling point S such that the sampling point S recedes from the fixed point V(xv,yv). The correction amount AS includes a correction amount ΔSx in the X-direction and a correction amount ΔSy in the Y-direction. The correction amounts ΔSx and ΔSy are fixed based on the second depth component D(w,h) of the first pixel P(w,h) corresponding to the target point O(xo,yo) in setting the sampling point S(xs,ys). For example, as illustrated in FIGS. 16A and 16B, the sampling point S is corrected by the correction amounts ΔSx and ΔSy that are fixed according to the depth information. As a result, the sampling coordinate is changed from S(xs,ys) to S′(xs′,ys′).

<S1206 and S1208> The parallax image generation (S1206) is executed similarly to that of the first embodiment. The parallax image generation is repeatedly executed until the number of executing times reaches n (NO in S1208). When the number of executing times of the parallax image generation reaches n (YES in S1208), the 2D-3D conversion is ended.

According to the second embodiment, the image processing apparatus 10a further includes the depth information generator 13 and the sampling point corrector 15. The depth information generator 13 generates the depth information indicating the depth of the first image expressed by the first image data based on the first brightness component of the pixel value of the first pixel. The sampling point corrector 15 corrects the sampling coordinate based on the depth information. As a result, the image data expressing the deep parallax image in units of pixels is generated. Therefore, compared with the first embodiment, the high-quality 3D image in which the depth of the 2D image is replicated more correctly can be obtained. Regarding the image in which the object is disposed on the front side while the background is disposed on the rear side, the deep parallax image in which the object is disposed on the more front side while the background is disposed on the more rear side is obtained.

When another value except the brightness component Y is used as the pixel component, as illustrated in Equation 4, the sampling point setting module 14 converts the brightness component Y of the first pixel PX into the brightness component Y′ of the second pixel PX′ using a filter FIL and a constant C corresponding to a tone range. For example, the filter FIL is a 3×3 filter (see Equation 5). For example, the constant C is 128 in the case of 256 tones. In this case, the brightness component Y′ of the second pixel PX′ is a brightness gradient component. Then, similarly to the case in which the brightness component Y is used as the pixel component, the sampling point setting module 14 sets the sampling point based on the brightness component Y′ of the second pixel PX′.

$$\begin{matrix}{Y}^{′} = Y \times FIL + C & ( Equation 4 ) \\ FIL = \{ \begin{matrix}- 1 & 0 & 1 \\ - 1 & 0 & 1 \\ - 1 & 0 & 1\end{matrix} & ( Equation 5 )\end{matrix}$$

The brightness component Y′ of the second pixel PX′ may also be a total of values in which the brightness component Y of the first pixel PX is multiplied by plural filters FIL0 to FIL2 and by plural weights a to c. In this case, the brightness component Y′ is expressed by Equation 6. Incidentally, the values of the filters FIL0 to FIL2 may be equal to one another or differ from one another. The value of the coefficients a to c may also be equal to one another or differ from one another.

Y′=a×Y×FIL0+b×Y×FIL1+c×Y×FIL2+C (Equation 6)

Moreover, in Equation 6, the brightness component Y′ is calculated using the three filters FIL0 to FIL2 by way of example. The number of filters used to calculate the brightness component Y′ and the value of the filter may arbitrarily be set. The plural filters FIL may also be weighted by the coefficients a, b, and c, respectively.

In addition, a brightness component Yr′ for the right eye may be calculated using plural filters FIL0r to FIL2r for the right eye, weights ar to cr for the right eye, and a constant Cr for the right eye (see Equation 7), and a brightness component Y1′ for the left eye may be calculated using plural filters FIL0l to FIL2l for the left eye, weights al to cl for the left eye, and a constant CI for the left eye (see Equation 8).

Yr′=ar×Y×FIL0r+br×Y×FIL1r+cr×Y×FIL2r+Cr (Equation 7)

Yl′=al×Y×FIL0l+bl×Y×FIL0l+cl×Y×FIL2l+Cl (Equation 8)

In addition, the brightness component Y used in Equations 4 and 6 to 8 may include the brightness components of the peripheral pixels around the attention pixel. For example, in the case of filtering with a 3×3 tap filter, the brightness components Y of nine pixels including the peripheral pixels around the attention pixel are used in Equations 4 and 6 to 8. Incidentally, when the peripheral pixels do not exist because the attention pixel is located at an end of the first image data IMG, the brightness component of the attention pixel may be interpolated using an arbitrary interpolation coefficient.

At least a portion of the image processing apparatus 10a according to the above-described embodiments may be composed of hardware or software. When at least a portion of the image processing apparatus 10a is composed of software, a program for executing at least some functions of the image processing apparatus 10a may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the image processing apparatus 10a according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus comprising:
a fixed point setting module configured to set a fixed point to a sampling coordinate space generated from first image data comprising a first pixel;
a sampling point setting module configured to set a target point to the sampling coordinate space, and set a sampling point corresponding to the target point to a sampling coordinate calculated based on a pixel component of the target point; and
a parallax image generator configured to calculate a pixel value of a second pixel to be located on the sampling coordinate, and generate plural pieces of second image data, each second image data comprising the second pixel.

2. The apparatus of claim 1, wherein the sampling point setting module calculates the sampling coordinate based on a distance between the fixed point and the target point.

3. The apparatus of claim 1, wherein the sampling point setting module calculates the sampling coordinate based on a pixel value of the target point.

4. The apparatus of claim 3, wherein the sampling point setting module calculates the sampling coordinate based on a brightness component in the pixel value of the target point.

5. The apparatus of claim 3, wherein the sampling point setting module applies a filter to a brightness component in the pixel value of the target point to generate a brightness gradient component, and calculates the sampling coordinate based on the brightness gradient component.

6. The apparatus of claim 1, further comprising:
a depth information generator configured to generate depth information based on a pixel value of the first pixel, the depth information indicating a depth of a first image expressed by the first image data; and
a sampling point corrector configured to correct the sampling coordinate based on the depth information.

7. The apparatus of claim 6, wherein
the depth information generator generates first depth information indicating a depth of the first image, and generates second depth information by linearly expanding the first depth information, and
the sampling point corrector corrects the sampling coordinate based on the second depth information.

8. The apparatus of claim 7, wherein the sampling point corrector corrects the sampling coordinate by a correction amount defined by a second depth component corresponding to the target point in the second depth information.

9. A method for having a computer process image, the method comprising:
generating a sampling coordinate space from first image data comprising a first pixel;
setting a fixed point and a target point to the sampling coordinate space;
calculating a sampling coordinate based on a pixel component of the target point;
setting a sampling point corresponding to the target point to the sampling coordinate;
calculating a pixel value of a second pixel to be located on the sampling coordinate; and
generating plural pieces of second image data, each second image data comprising the second pixel.

10. The method of claim 9, wherein in generating the sampling coordinate space, the sampling coordinate is calculated based on a distance between the fixed point and the target point.

11. The method of claim 9, wherein in generating the sampling coordinate space, the sampling coordinate is calculated based on a pixel value of the target point.

12. The method of claim 11, wherein in generating the sampling coordinate space, the sampling coordinate is calculated based on a brightness component in the pixel value of the target point.

13. The method of claim 11, wherein in generating the sampling coordinate space,
a filter is applied to a brightness component in the pixel value of the target point, to generate a brightness gradient component, and
the sampling coordinate is calculated based on the brightness gradient component.

14. The method of claim 9, further comprising:
generating depth information based on a pixel value of the first pixel, the depth information indicating a depth of a first image expressed by the first image data; and
correcting the sampling coordinate based on the depth information.

15. The method of claim 14, wherein in generating the depth information, first depth information indicating a depth of the first image is generated, and second depth information is generated by linearly expanding the first depth information, and
wherein in correcting the sampling coordinate, the sampling coordinate is corrected based on the second depth information.

16. The method of claim 15, wherein in correcting the sampling point, the sampling coordinate is corrected by a correction amount defined by a second depth component corresponding to the target point in the second depth information.

17. A computer readable medium storing a computer program code for having a computer process image, the computer program code comprising:
generating a sampling coordinate space from first image data comprising a first pixel;
setting a fixed point and a target point to the sampling coordinate space;
calculating a sampling coordinate based on a pixel component of the target point;
setting a sampling point corresponding to the target point to the sampling coordinate;
calculating a pixel value of a second pixel to be located on the sampling coordinate; and
generating plural pieces of second image data, each second image data comprising the second pixel.

18. The medium of claim 17, wherein in generating the sampling coordinate space, the sampling coordinate is calculated based on a distance between the fixed point and the target point.

19. The medium of claim 17, wherein in generating the sampling coordinate space, the sampling coordinate is calculated based on a pixel value of the target point.

20. The medium of claim 19, wherein in generating the sampling coordinate space, the sampling coordinate is calculated based on a brightness component in the pixel value of the target point.
